(19) United States
(12) Patent Application Publication
(10) Pub. No.: US 2014/0308899 A1
(43) Pub. Date: Oct. 16, 2014

(54) MULTI-STANDARDS TRANSCEIVER

(71) Applicant: MEDIATEK INC., Hsin-Chu (TW)

(72) Inventors: Tsung-Ming Chen, Hsinchu County (TW); Chia-Hsin Wu, New Taipei City (TW); Albert Chia-Wen Jerng, Los Gatos, CA (US); George Chien, Saratoga, CA (US)

(73) Assignee: MEDIATEK INC., Hsin-Chu (TW)

(21) Appl. No.: 14/139,885

(22) Filed: Dec. 24, 2013

Related U.S. Application Data
(60) Provisional application No. 61/810,368, filed on Apr. 10, 2013.

(51) Int. Cl. H04B 1/50

(52) U.S. Cl. CPC H04B 1/50
USPC 455/42

(57) ABSTRACT

A multi-standards transceiver includes: a first synthesizer arranged to generate a first oscillating signal; a second synthesizer arranged to generate a second oscillating signal; a first transceiver; a second transceiver; and a multiplexer coupled to the first synthesizer and the second synthesizer; wherein when the multi-standards transceiver operates under a first frequency mode, the first transceiver is arranged to use the first oscillating signal to modulate a first analog signal and the multiplexer is arranged to output the second oscillating signal to the second transceiver so that the second transceiver uses the second oscillating signal to modulate a second analog signal.

### CROSS REFERENCE TO RELATED APPLICATIONS

This application claims the benefit of U.S. provisional Application No. 61/810,368, which was filed on 2013 Apr. 10 and is included herein by reference.

### BACKGROUND

The present invention relates to a multi-standards transceiver, and more particularly to a single-chip transceiver capable of transmitting/receiving an RF signal on two non-contiguous channels.

In some countries, the frequency spectrum assigned for a specific WLAN (wireless local area networks) system is not contiguous. For example, the bandwidth of the WLAN system defined in IEEE 802.11ac is 160 MHz on the 5 GHz frequency band, and the 160 MHz bandwidth may consist of two non-contiguous segments, e.g. a frequency channel of 80 MHz plus another frequency channel of 80 MHz on the 5 GHz frequency band. As a result, a wireless transceiver used in this kind of WLAN system should have the capability to generate two carrier signals, one with the frequency corresponding to the first 80 MHz channel on the 5 GHz band, and the other with the frequency corresponding to the second 80 MHz channel on the 5 GHz band. One of the possible ways to solve the above problem is the two separated chips solution, in which the first chip is a transceiver used to deal with the signal in the first 80 MHz channel on the 5 GHz band, and the second chip is the other transceiver used to deal with the signal in the second 80 MHz channel on the 5 GHz band. The cost of this solution is too high, however, due to the two separated chips. Therefore, providing a low cost and high throughput transceiver to concurrently transmit/receive signal on different frequency channels on a specific frequency band and/or to concurrently transmit/receive signal on different frequency bands of different communications standards is an urgent problem in this field.

### SUMMARY

One of the objectives of the present embodiment is to provide a single-chip transceiver capable of transmitting/receiving an RF signal on two non-contiguous channels.

According to a first embodiment of the present invention, a multi-standards transceiver is provided. The multi-standards transceiver comprises a first synthesizer, a second synthesizer, a first transceiver, a second transceiver, and a multiplexer. The first synthesizer is arranged to generate a first oscillating signal. The second synthesizer is arranged to generate a second oscillating signal. The multiplexer is coupled to the first synthesizer and the second synthesizer, wherein when the multi-standards transceiver operates under a first frequency mode, the first transceiver is arranged to use the first oscillating signal to modulate a first analog signal and the multiplexer is arranged to output the second oscillating signal to the second transceiver so that the second transceiver uses the second oscillating signal to modulate a second analog signal.

According to a second embodiment of the present invention, a multi-standards transceiver is provided. The multi-standards transceiver comprises a first synthesizer, a second synthesizer, a first transceiver, and a second transceiver. The first synthesizer is arranged to generate a first oscillating signal. The second synthesizer is arranged to generate a second oscillating signal, wherein when the multi-standards transceiver operates under a first frequency mode, the first transceiver is arranged to use the first oscillating signal and the second oscillating signal to modulate a first analog signal and a second analog signal respectively.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a multi-standards transceiver according to a first embodiment of the present invention.

FIG. 2 is a spectrum diagram illustrating two non-contiguous channels on a frequency band with respect to a wireless communication standard according to an embodiment of the present invention.

FIG. 3 is a spectrum diagram illustrating one contiguous channel on a frequency band with respect to a wireless communication standard according to an embodiment of the present invention.

FIG. 4 is a diagram illustrating the multi-standards transceiver operating under a second frequency mode according to an embodiment of the present invention.

FIG. 5 is a diagram illustrating the multi-standards transceiver operating under a third frequency mode according to an embodiment of the present invention.

FIG. 6 is a diagram illustrating a multi-standards transceiver according to a second embodiment of the present invention.

FIG. 7 is a diagram illustrating a transmitter according to a first embodiment of the present invention.

FIG. 8 is a diagram illustrating a transmitter according to a second embodiment of the present invention.

FIG. 9 is a diagram illustrating a transmitter according to a third embodiment of the present invention.

FIG. 10 is a diagram illustrating a transmitter according to a fourth embodiment of the present invention.

FIG. 11 is a diagram illustrating a receiver according to a first embodiment of the present invention.

FIG. 12 is a diagram illustrating a receiver according to a second embodiment of the present invention.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

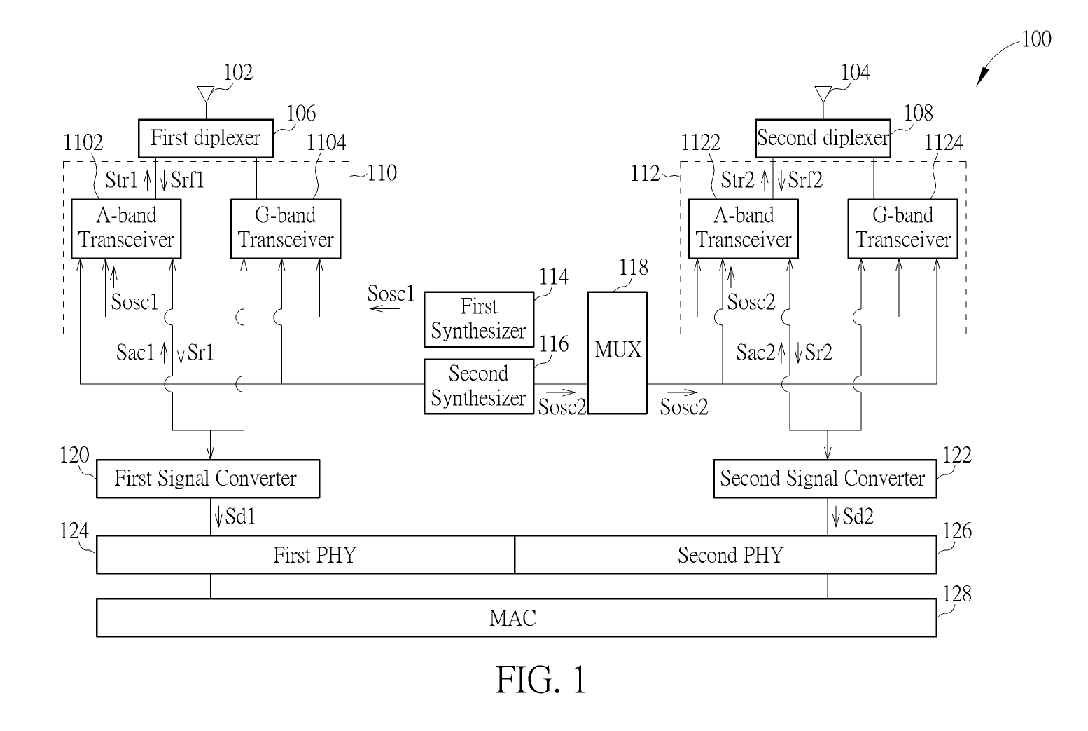

Please refer to FIG. 1, which is a diagram illustrating a multi-standards transceiver 100 according to a first embodiment of the present invention. The multi-standards transceiver 100 comprises a first antenna 102, a second antenna 104, a first diplexer 106, a second diplexer 108, a first transceiver 110, a second transceiver 112, a first synthesizer 114, a second synthesizer 116, a multiplexer (MUX) 118, a first signal converter 120, a second signal converter 122, a first physical layer (PHY) 124, a second physical layer 126, and a media access controller (MAC) 128. The first transceiver 110, the second transceiver 112, the first synthesizer 114, the second synthesizer 116, the multiplexer 118, the first signal converter 120, the second signal converter 122, the first physical layer 124, the second physical layer 126, and the media access controller 128 are configured as a single chip. The first antenna 102, the second antenna 104, the first diplexer 106, and the second diplexer 108 are externally coupled to the single chip. This is not a limitation of the present invention, however.

The first transceiver 110 and the second transceiver 112 are multi-standards transceivers that the first transceiver 110 and the second transceiver 112 can be applied in various wireless communications standards. For example, the wireless communications standard can be WLAN (wireless local area networks) system defined in the specification of IEEE (Institute of Electrical and Electronics Engineers) 802.11ac, WLAN system defined in the specification of IEEE 802.11b/g, and 2*2 MIMO (Multiple Input, Multiple Output) system. Therefore, the first transceiver 110 comprises an A-band transceiver 1102 and a G-band transceiver 1104, and the second transceiver 112 also comprises an A-band transceiver 1122 and a G-band transceiver 1124, in which the A-band transceiver 1102 and the A-band transceiver 1122 are arranged to operate under the WLAN defined by IEEE 802.11ac, and the G-band transceiver 1104 and G-band transceiver 1124 are arranged to operate under the WLAN defined by IEEE 802.11b/g. It is noted that the A-band is the frequency band substantially on 5.2 GHz, and the G-band is the frequency band substantially on 2.4 GHz.

The first synthesizer 114 and the second synthesizer 116 are also the multi-standards synthesizers. Therefore, the first synthesizer 114 and the second synthesizer 116 can be arranged to selectively generate the A-band oscillating frequency and/or the G-band oscillating frequency according to the frequency mode of the multi-standards transceiver 100.

In addition, the first signal converter 120 comprises a low-pass filter, an analog-to-digital converter (ADC), and a digital-to-analog converter (DAC), in which the low-pass filter is an intermediate frequency low-pass filter, the ADC is arranged to convert an analog signal received from the first transceiver 110 into a digital signal for the first physical layer 124 during the receiving mode of the multi-standards transceiver 100, and the DAC is arranged to convert a digital signal received from the first physical layer 124 into an analog signal for the first transceiver 110 during the transmitting mode of the multi-standards transceiver 100. The second signal converter 122 also comprises a low-pass filter, an ADC, and a DAC, in which the low-pass filter is an intermediate frequency low-pass filter, the ADC is arranged to convert an analog signal received from the second transceiver 112 into a digital signal for the second physical layer 126 during the receiving mode of the multi-standards transceiver 100, and the DAC is arranged to convert a digital signal received from the second physical layer 126 into an analog signal for the second transceiver 112 during the transmitting mode of the multi-standards transceiver 100.

The multiplexer 118 is coupled to the first synthesizer 114 and the second synthesizer 116, and the multiplexer 118 is arranged to selectively output one of the oscillating signals outputted by the first synthesizer 114 and the second synthesizer 116 to the second transceiver 112.

The following paragraph describes the operation of the multi-standards transceiver 100 during different modes.

When the multi-standards transceiver 100 operates under a first frequency mode:

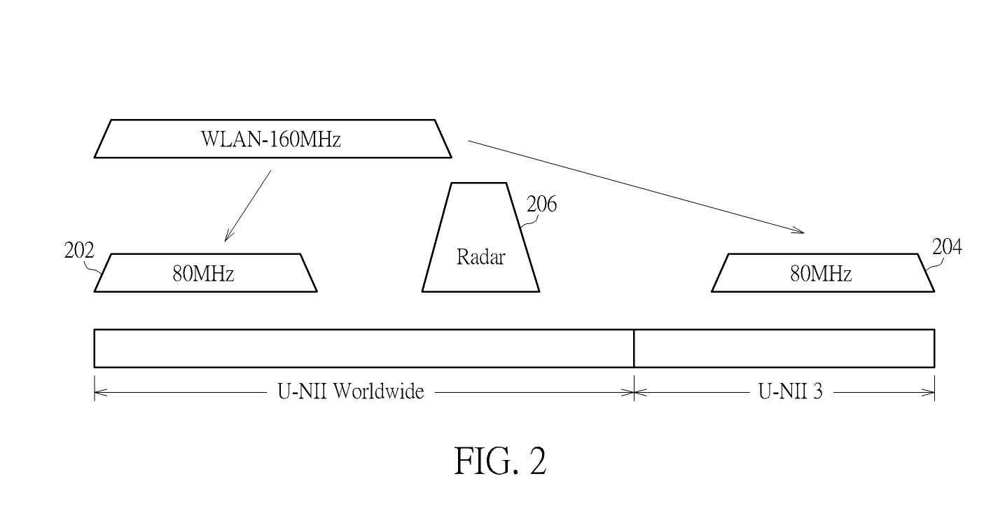

During the first frequency mode, the multi-standards transceiver 100 transmits/receives the RF (Radio Frequency) signal on the frequency channels consists of two non-contiguous channels on a frequency band as shown in FIG. 2. FIG. 2 is a spectrum diagram illustrating two non-contiguous channels (i.e. a first frequency channel 202 and a second frequency channel 204) on a frequency band with respect to a wireless communication standard according to an embodiment of the present invention. For example, the wireless communication standard is the standard defined by the specification of IEEE 802.11ac, thus the frequency band is around 5.2 GHz, and the first frequency channel 202 has a bandwidth of 80 MHz and the second frequency channel 204 also has a bandwidth of 80 MHz. According to this embodiment, the first frequency channel 202 is on the U-NII (Unlicensed-National Information Infrastructure) worldwide, the second frequency channel 204 is on the U-NII 3, and a specific radar channel 206 is on the U-NII worldwide that separates the second frequency channel 204 from the first frequency channel 202.

Therefore, when the multi-standards transceiver 100 transmits/receives the RF signal on the first frequency channel 202 and the second frequency channel 204 (see FIG. 1), the first synthesizer 114 is arranged to generate a first oscillating signal Sosc1 to modulate (e.g. up-convert/down-convert) an analog signal corresponding to the first frequency channel 202, and the second synthesizer 116 is arranged to generate a second oscillating signal Sosc2 to modulate (e.g. up-convert/down-convert) an analog signal corresponding to the second frequency channel 204. More specifically, if the multi-standards transceiver 100 operates under the transmitting mode, a transmitter in the A-band transceiver 1102 is arranged to up-convert the first analog signal Sac1 outputted from the DAC in the first signal converter 120 into a first transmitting signal Str1 by the first oscillating signal Sosc1, and a transmitter in the A-band transceiver 1122 is arranged to up-convert the second analog signal Sac2 outputted from the DAC in the second signal converter 122 into a second transmitting signal Str2 by the second oscillating signal Sosc2. If the multi-standards transceiver 100 operates under the receiving mode, a receiver in the A-band transceiver 1102 is arranged to down-convert the first RF signal Srf1 received by the first antenna 102 into a first receiving analog signal Sr1 by the first oscillating signal Sosc1, and a receiver in the A-band transceiver 1122 is arranged to down-convert the second RF signal Srf2 received by the second antenna 104 into a second receiving analog signal Sr2 by the second oscillating signal Sosc2.

When the multi-standards transceiver 100 transmits/receives the RF signal on the first frequency channel 202 and the second frequency channel 204, the multiplexer 118 is controlled to output the second oscillating signal Sosc2 generated by the second synthesizer 116 to the second transceiver 112 (i.e. the dashed line in the multiplexer 118) while the first transceiver 110 directly receives the first oscillating signal Sosc1 generated by the first synthesizer 114.

Accordingly, the multi-standards transceiver 100 is able to transmit/receive the RF signal on two non-contiguous channels (e.g. the first frequency channel 202 and the second frequency channel 204) on a frequency band.

If the two non-contiguous channels are on the frequency band of the wireless communication standard defined by the specification of IEEE 802.11b/g, then the frequency band is around 2.4 GHz. Similarly, the first synthesizer 114 can also be arranged to generate a first oscillating signal with oscillation frequency around 2.4 GHz to modulate (e.g. up-convert/down-convert) the analog signal corresponding to the first non-contiguous frequency channel on the 2.4 GHz frequency band, and the second synthesizer 116 can also be arranged to generate a second oscillating signal to modulate (e.g. up-convert/down-convert) the analog signal corresponding to the second non-contiguous frequency channel on the 2.4 GHz frequency band. Thus, the multiplexer 118 is controlled to output the second oscillating signal generated by the second synthesizer 116 to the second transceiver 112 while the first transceiver 110 directly receives the first oscillating signal generated by the first synthesizer 114. As the operation is similar to the case of when the multi-standards transceiver 100 operates under IEEE 802.11ac, the detailed description is omitted here for brevity.

When the multi-standards transceiver 100 operates under a second frequency mode:

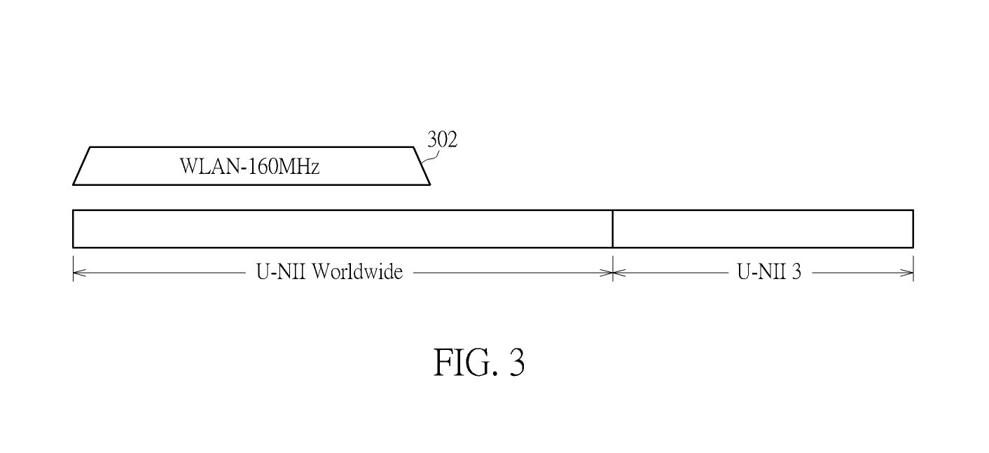

During the second frequency mode, the multi-standards transceiver 100 transmits/receives the RF signal on one contiguous frequency channel on a frequency band as shown in FIG. 3. FIG. 3 is a spectrum diagram illustrating one contiguous channel (i.e. the frequency channel 302) on a frequency band with respect to a wireless communication standard according to an embodiment of the present invention. For example, the wireless communication standard is the standard defined by the specification of IEEE 802.11ac, thus the frequency band is around 5.2 GHz, and the frequency channel 302 has bandwidth of 160 MHz. According to this embodiment, the frequency channel 302 is on the U-NII (Unlicensed-National Information Infrastructure) worldwide.

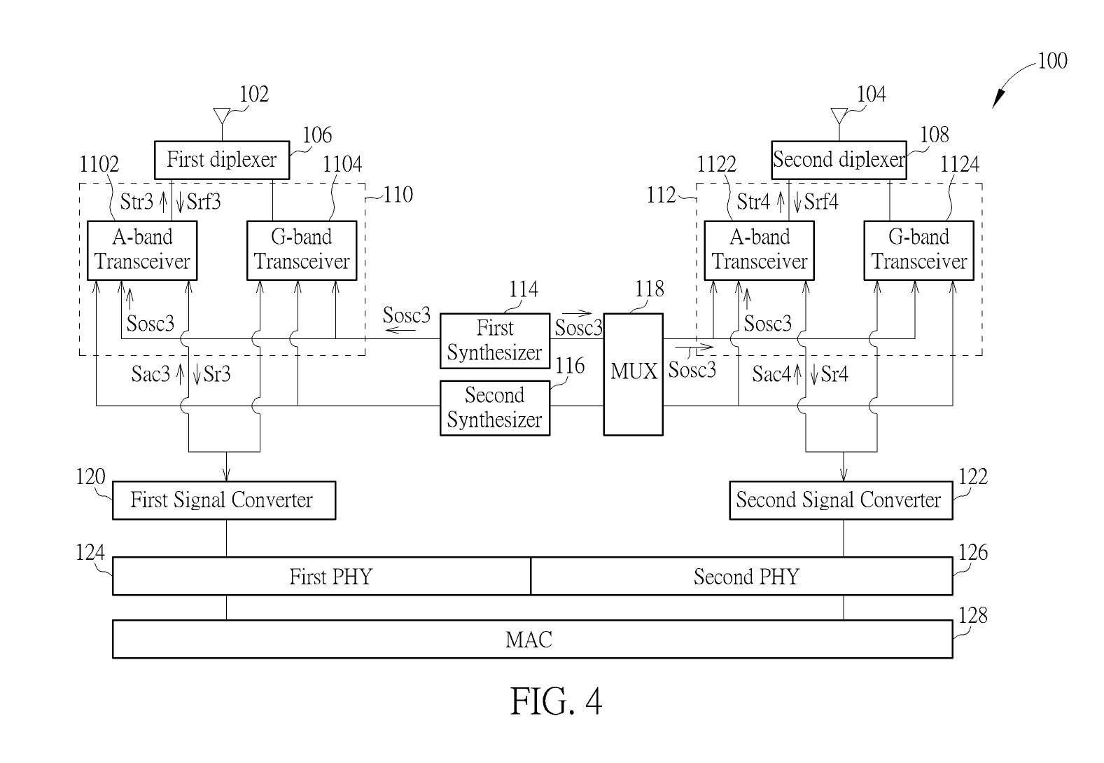

Please refer to FIG. 4, which is a diagram illustrating the multi-standards transceiver 100 operating under the second frequency mode according to an embodiment of the present invention. When the multi-standards transceiver 100 transmits/receives the RF signal on the frequency channel 302, the first synthesizer 114 is arranged to generate a third oscillating signal Sosc3 to modulate (e.g. up-convert/down-convert) an analog signal corresponding to the frequency channel 302. More specifically, when the multi-standards transceiver 100 operates under the second frequency mode, the first synthesizer 114 is arranged to generate the third oscillating signal Sosc3 to the A-band transceiver 1102 and the A-band transceiver 1122 to modulate the analog signal corresponding to the frequency channel 302. If the multi-standards transceiver 100 operates under the transmitting mode, a transmitter in the A-band transceiver 1102 is arranged to up-convert the third analog signal Sac3 outputted from the DAC in the first signal converter 120 into a third transmitting signal Str3 by the third oscillating signal Sosc3, and a transmitter in the A-band transceiver 1122 is arranged to up-convert the fourth analog signal Sac4 outputted from the DAC in the second signal converter 122 into a fourth transmitting signal Str4 by the third oscillating signal Sosc3. If the multi-standards transceiver 100 operates under the receiving mode, a receiver in the A-band transceiver 1102 is arranged to down-convert the third RF signal Srf3 received by the first antenna 102 into a third receiving analog signal Sr3 by the third oscillating signal Sosc3, and a receiver in the A-band transceiver 1122 is arranged to down-convert the fourth RF signal Srf4 received by the second antenna 104 into a third receiving analog signal Sr4 by the third oscillating signal Sosc3.

Therefore, when the multi-standards transceiver 100 transmits/receives the RF signal on the frequency channel 302, the multiplexer 118 is controlled to output the third oscillating signal Sosc3 generated by the first synthesizer 114 to the second transceiver 112 while the first transceiver 110 directly receives the third oscillating signal Sosc3 generated by the first synthesizer 114.

Accordingly, the multi-standards transceiver 100 is able to transmit/receive the RF signal on one contiguous channel (e.g. the frequency channel 302) on a frequency band.

If the two non-contiguous channels are on the frequency band of the wireless communication standard defined by the specification of IEEE 802.11b/g, then the frequency band is around 2.4 GHz. Similarly, the first synthesizer 114 can also be arranged to generate a third oscillating signal with oscillation frequency around 2.4 GHz to modulate (e.g. up-convert/down-convert) the analog signal corresponding to the contiguous frequency channel. Thus, the multiplexer 118 is controlled to output the third oscillating signal generated by the first synthesizer 114 to the second transceiver 112 while the first transceiver 110 directly receives the third oscillating signal generated by the first synthesizer 114. As the operation is similar to the case of when the multi-standards transceiver 100 operates under IEEE 802.11ac, the detailed description is omitted here for brevity.

It should be noted that the above mentioned second frequency mode is similar to the operation of the 2*2 MIMO system; the detailed description of the operation of the 2*2 MIMO system is therefore omitted here for brevity.

When the multi-standards transceiver 100 operates under a third frequency mode:

During the third frequency mode, which is a dual-band concurrent mode, the multi-standards transceiver 100 transmits/receives the RF signal on the frequency channels consist of two different frequency bands concurrently, the first frequency band corresponds to a first communications standard and the second frequency band corresponds to a second communications standard different from the first communications standard. For example, the first communications standard is the wireless communications standard defined by the specification of IEEE 802.11ac, and the second communications standard is the wireless communications standard defined by the specification of IEEE 802.11b/g. Therefore, the first frequency band is the band around 5.2 GHz and the second frequency band is the band around 2.4 GHz. An example of a dual-band concurrent application is when a mobile device receives a video signal from the WLAN (e.g. the Youtube website), and meanwhile the mobile device transmits the received video signal to a displayer for displaying the video. By installing the multi-standards transceiver 100 into the mobile device, the mobile device can be used to receive the video signal from the internet via the first frequency band (e.g. 5.2 GHz) and transmit the received video signal to the displayer via the second frequency band (e.g. 2.4 GHz) concurrently.

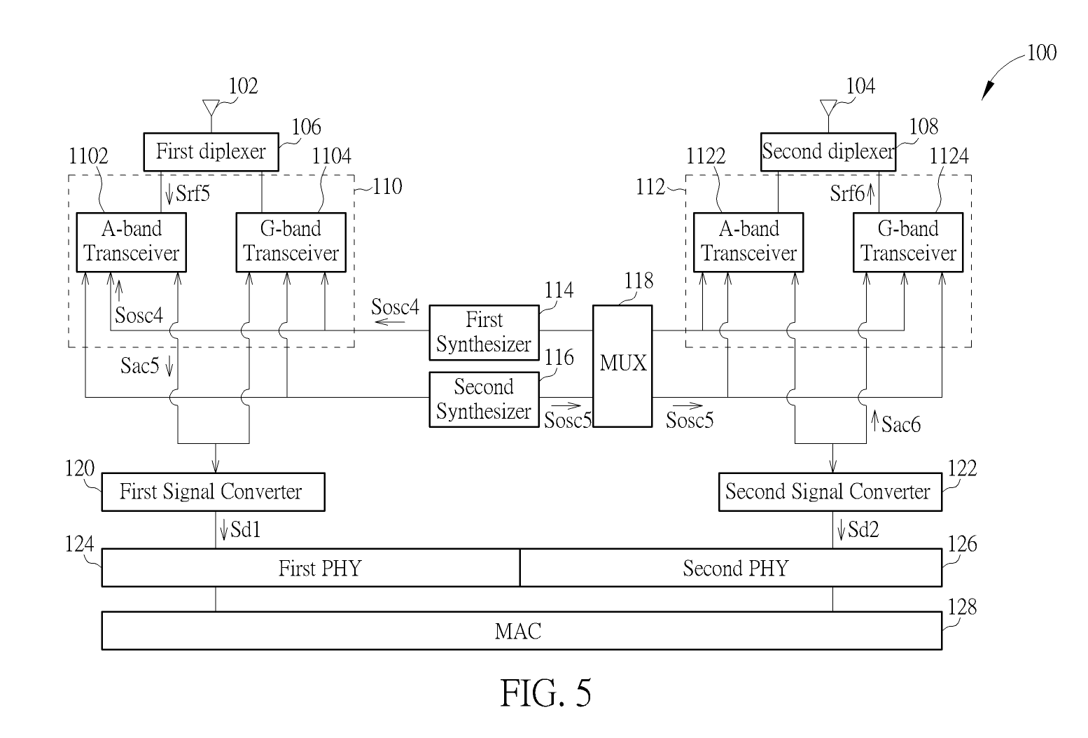

Please refer to FIG. 5, which is a diagram illustrating the multi-standards transceiver 100 operating under the third frequency mode according to an embodiment of the present invention. When the multi-standards transceiver 100 operates under the third frequency mode, the first synthesizer 114 is arranged to generate a fourth oscillating signal Sosc4 to the receiver in the A-band transceiver 1102 to modulate (e.g. down-convert) a fifth RF signal Srf5 on the first frequency band for generating a fifth analog signal Sac5 to the ADC in the first signal converter 120. Meanwhile, the second synthesizer 116 is arranged to generate a fifth oscillating signal Sosc5 to the transmitter in the G-band transceiver 1124 to modulate (e.g. up-convert) a sixth analog signal Sac6 generated by the DAC in the second signal converter 122 into a sixth RF signal Srf6 for the second antenna 104. It should be noted that, when the ADC in the first signal converter 120 converts the fifth analog signal Sac5 into a first digital signal Sd1, then the first physical layer 124, the second physical layer 126, and the media access controller 128 are arranged to generate a second digital signal Sd2 to the DAC of the second signal converter 122 according to the first digital signal Sd1. Then, the DAC in the second signal converter 122 converts the second digital signal Sd2 into the sixth analog signal Sac6. Accordingly, the video signal received from the WLAN can be concurrently transmitted to the displayer.

It should also be noted that, in the above embodiment in FIG. 5, the multi-standards transceiver 100 is arranged to use the A-band transceiver 1102 to receive the video signal from the WLAN and to use the G-band transceiver 1124 to transmit the received video signal to the displayer, but this is not a limitation of the present invention. In another embodiment of the present invention, the multi-standards transceiver 100 can also be arranged to use the G-band transceiver 1104 to receive the video signal from the WLAN and to use the A-band transceiver 1122 to transmit the received video signal to the displayer, or to use the A-band transceiver 1122 to receive the video signal from the WLAN and to use the G-band transceiver 1104 to transmit the received video signal to the displayer, or to use the G-band transceiver 1124 to receive the video signal from the WLAN and to use the A-band transceiver 1102 to transmit the received video signal to the displayer, which also belongs to the scope of the present invention. Those skilled in the art should understand these operations after reading the disclosure in FIG. 5; the detailed description is therefore omitted here for brevity.

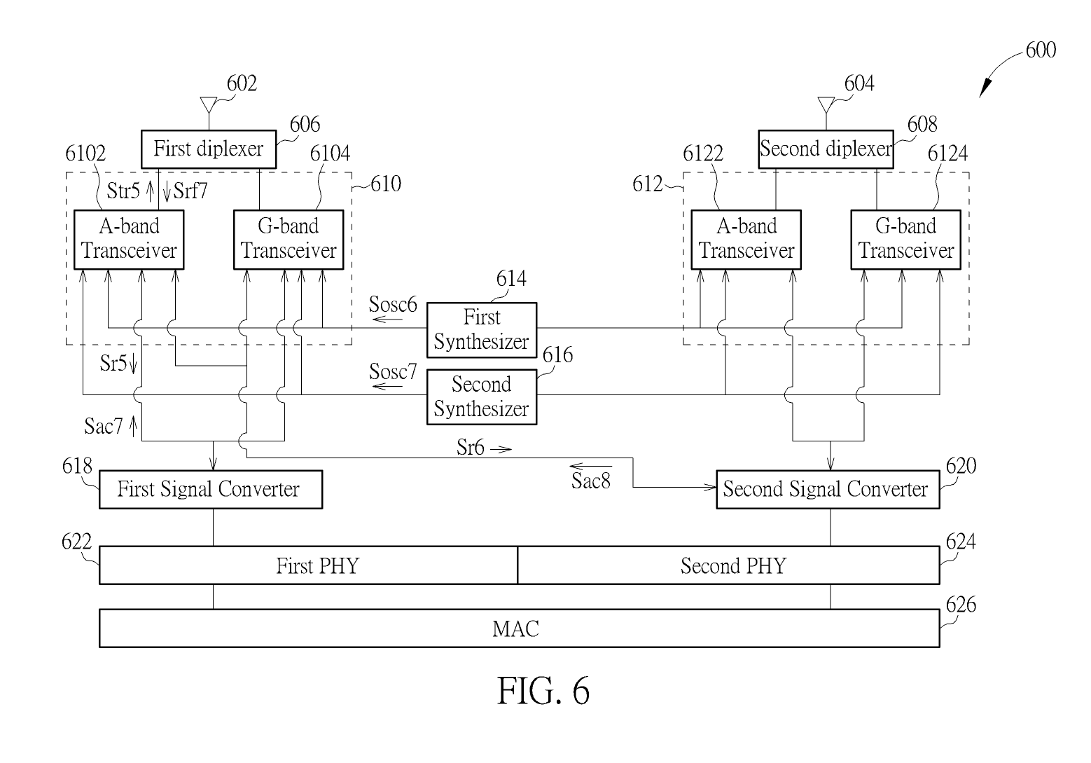

Please note that, according to the embodiment shown in FIG. 1, the multi-standards transceiver 100 can also be arranged to use the first synthesizer 114 and the second synthesizer 116 to concurrently output a first oscillating signal and a second oscillating signal to the A-band transceiver 1102 (or the G-band transceiver 1104) respectively meanwhile the A-band transceiver 1122 and the G-band transceiver 1124 are disabled (or powered off). The first oscillating signal and the second oscillating signal are on two different frequency channels in one frequency band respectively. Accordingly, in this single antenna mode, the A-band transceiver 1102 (or the G-band transceiver 1104) is arranged to modulate a pre-transmit analog signal or a received analog signal by the first oscillating signal and the second oscillating signal, wherein both of the pre-transmit analog signal and the received analog signal are the signals on the two different frequency channels in the frequency band. The operation of the single antenna mode is shown in FIG. 6.

Please refer to FIG. 6, which is a diagram illustrating a multi-standards transceiver 600 according to a second embodiment of the present invention. The multi-standards transceiver 600 comprises a first antenna 602, a second antenna 604, a first diplexer 606, a second diplexer 608, a first transceiver 610, a second transceiver 612, a first synthesizer 614, a second synthesizer 616, a first signal converter 618, a second signal converter 620, a first physical layer (PHY) 622, a second physical layer 624, and a media access controller (MAC) 626. The first transceiver 610, the second transceiver 612, the first synthesizer 614, the second synthesizer 616, the first signal converter 618, the second signal converter 620, the first physical layer 622, the second physical layer 624, and the media access controller 626 are configured as a single chip.

The first transceiver 610 and the second transceiver 612 are multi-standards transceivers that the first transceiver 610 and the second transceiver 612 can be applied in various wireless communications standards, e.g. WLAN (wireless local area networks) system defined in the specification of IEEE (Institute of Electrical and Electronics Engineers) 802.11ac, WLAN system defined in the specification of IEEE 802.11b/g, and 2*2 MIMO (Multiple Input, Multiple Output) system. Therefore, the first transceiver 610 comprises an A-band transceiver 6102 and a G-band transceiver 6104, and the second transceiver 612 also comprises an A-band transceiver 6122 and a G-band transceiver 6124, in which the A-band transceiver 6102 and the A-band transceiver 6122 are arranged to operate under the WLAN defined by IEEE 802.11ac, and the G-band transceiver 6104 and G-band transceiver 6124 are arranged to operate under the WLAN defined by IEEE 802.11b/g.

The first synthesizer 614 and the second synthesizer 616 are also the multi-standards synthesizers. Therefore, the first synthesizer 614 and the second synthesizer 616 can be arranged to selectively generate the A-band oscillating frequency or the G-band oscillating frequency according to the frequency mode of the multi-standards transceiver 600.

In addition, the first signal converter 618 comprises a low-pass filter, an analog-to-digital converter (ADC), and a digital-to-analog converter (DAC), in which the low-pass filter is an intermediate frequency low-pass filter, the ADC is arranged to convert an analog signal received from the first transceiver 610 into a digital signal for the first physical layer 622 during the receiving mode of the multi-standards transceiver 600, and the DAC is arranged to convert a digital signal received from the first physical layer 622 into an analog signal for the first transceiver 610 during the transmitting mode of the multi-standards transceiver 600. The first signal converter 620 also comprises a low-pass filter, an ADC, and a DAC, in which the low-pass filter is an intermediate frequency low-pass filter, the ADC is arranged to convert an analog signal received from the first transceiver 610 or the second transceiver 612 into a digital signal for the second physical layer 624 during the receiving mode of the multi-standards transceiver 600, and the DAC is arranged to convert a digital signal received from the first physical layer 622 into an analog signal for the first transceiver 610 or the second transceiver 612 during the transmitting mode of the multi-standards transceiver 600.

The following paragraph describes the operation of the multi-standards transceiver 600 during different modes.

When the multi-standards transceiver 600 operates under a single antenna mode:

During the single antenna mode, the multi-standards transceiver 600 transmits/receives the RF (Radio Frequency) signal on the frequency channels consists of two non-contiguous channels on a frequency band as shown in above-mentioned FIG. 2.

Therefore, when the multi-standards transceiver 600 transmits/receives the RF signal on the first frequency channel 202 and the second frequency channel 204, the second transceiver 612 is disabled (or powered off), the first synthesizer 614 is arranged to generate a sixth oscillating signal Sosc6 to modulate (e.g. up-convert/down-convert) an analog signal corresponding to the first frequency channel 202, and the second synthesizer 616 is arranged to generate a seventh oscillating signal Sosc7 to modulate (e.g. up-convert/down-convert) an analog signal corresponding to the second frequency channel 204. More specifically, if the multi-standards transceiver 600 operates under the transmitting mode, a transmitter in the A-band transceiver 6102 is arranged to up-convert the seventh analog signal Sac7 outputted from the DAC in the first signal converter 618 into a fifth transmitting signal Str5 by the sixth oscillating signal Sosc6, and the transmitter in the A-band transceiver 6102 is also arranged to up-convert the eighth analog signal Sac8 outputted from the DAC in the second signal converter 620 into the fifth transmitting signal Str5 by the seventh oscillating signal Sosc7. If the multi-standards transceiver 600 operates under the receiving mode, a receiver in the A-band transceiver 6102 is arranged to down-convert the seventh RF signal Srf7 received by the first antenna 602 into a fifth receiving analog signal Sr5 by the sixth oscillating signal Sosc6, and the receiver in the A-band transceiver 6102 is also arranged to down-convert the seventh RF signal Srf7 received by the first antenna 602 into a sixth receiving analog signal Sr6 by the seventh oscillating signal Sosc7.

Therefore, when the multi-standards transceiver 600 transmits/receives the RF signal on the first frequency channel 202 and the second frequency channel 204, the first synthesizer 614 and the second synthesizer 616 are arranged to generate the sixth oscillating signal Sosc6 and the seventh oscillating signal Sosc7 to the A-band transceiver 6102 respectively, and the first signal converter 618 and the second signal converter 620 are arranged to convert the analog signal to/from the A-band transceiver 6102.

Accordingly, the multi-standards transceiver 600 is able to transmit/receive the RF signal on two non-contiguous channels (e.g. the first frequency channel 202 and the second frequency channel 204) on one frequency band by using the single antenna 602.

If the two non-contiguous channels are on the frequency band of the wireless communication standard defined by the specification of IEEE 802.11b/g, then the frequency band is around 2.4 GHz. Similarly, the first synthesizer 614 can also be arranged to generate a first oscillating signal with oscillation frequency around 2.4 GHz to the G-band transceiver 6104 to modulate (e.g. up-convert/down-convert) the analog signal corresponding to the first non-contiguous frequency channel, and the second synthesizer 616 can also be arranged to generate a second oscillating signal to the G-band transceiver 6104 to modulate (e.g. up-convert/down-convert) the analog signal corresponding to the second non-contiguous frequency channel. As the operation is similar to the case of when the multi-standards transceiver 600 operates under IEEE 802.11ac, the detailed description is omitted here for brevity.

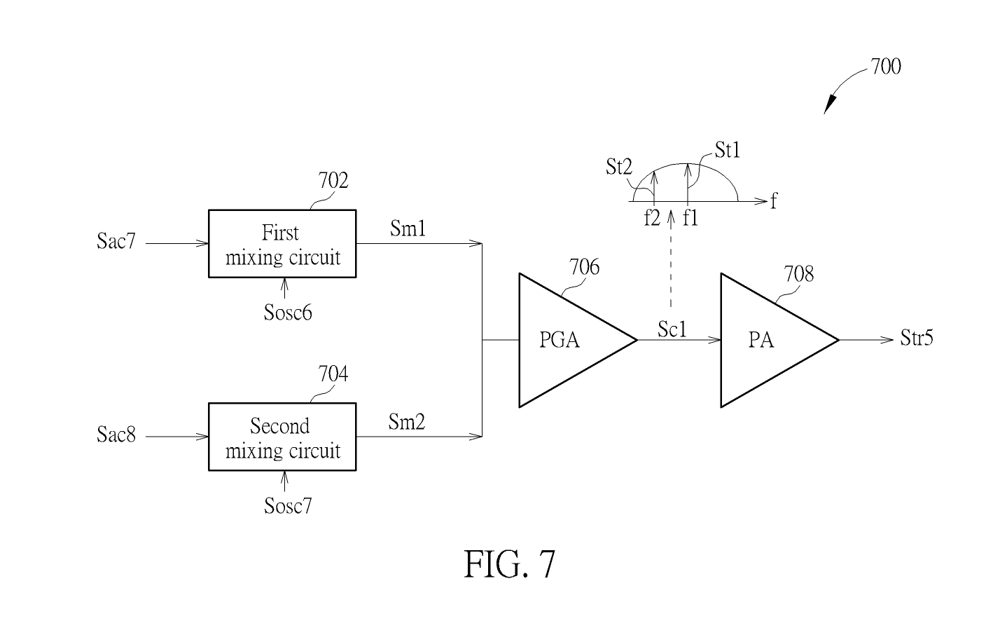

It is noted that when the multi-standards transceiver 600 operates under the single antenna mode, only one antenna (i.e. the first antenna 602 or the second antenna 604) is being used to receive or transmit an RF signal. Therefore, the transceiver (i.e. the A-band transceivers 6102, 6122, and the G-band transceivers 6104, 6124) should have the ability to combine two analog signals into one pre-transmit analog signal during the transmitting mode and to separate one received RF signal into two analog signals during the receiving mode. Please refer to FIG. 7, which is a diagram illustrating a transmitter 700 according to a first embodiment of the present invention. The transmitter 700 can be the transmitter in the A-band transceivers 6102, 6122, and the G-band transceivers 6104, 6124. The transmitter 700 comprises a first mixing circuit 702, a second mixing circuit 704, a programmable gain amplifier (PGA) 706, and a power amplifier (PA) 708. The first mixing circuit 702 is arranged to modulate the seventh analog signal Sosc7 to generate a first modulated signal 5 ml according to the sixth oscillating signal Sosc6. The second mixing circuit 704 is arranged to modulate the eighth analog signal Sac8 to generate a second modulated signal Sm2 according to the seventh oscillating signal Sosc7. The programmable gain amplifier 706 is arranged to combine the first modulated signal 5 ml and the second modulated signal Sm2 to generate a combined signal Sc1. The power amplifier 708 is arranged to generate an amplified signal to an antenna (not shown) according to the combined signal Sc1, wherein the amplified signal is the fifth transmitting signal Str5 being transmitted to the first diplexer 606. According to FIG. 7, the combined signal Sc1 comprises two signal tones St1 and St2 on frequencies f1 and f2 respectively. The first signal tone St1 corresponds to the up-conversion of the seventh analog signal Sac7 and the second signal tone St2 corresponds to the up-conversion of the eighth analog signal Sac8. Therefore, the first frequency f1 is on the first frequency channel 202 and the second frequency f2 is on the second frequency channel 204.

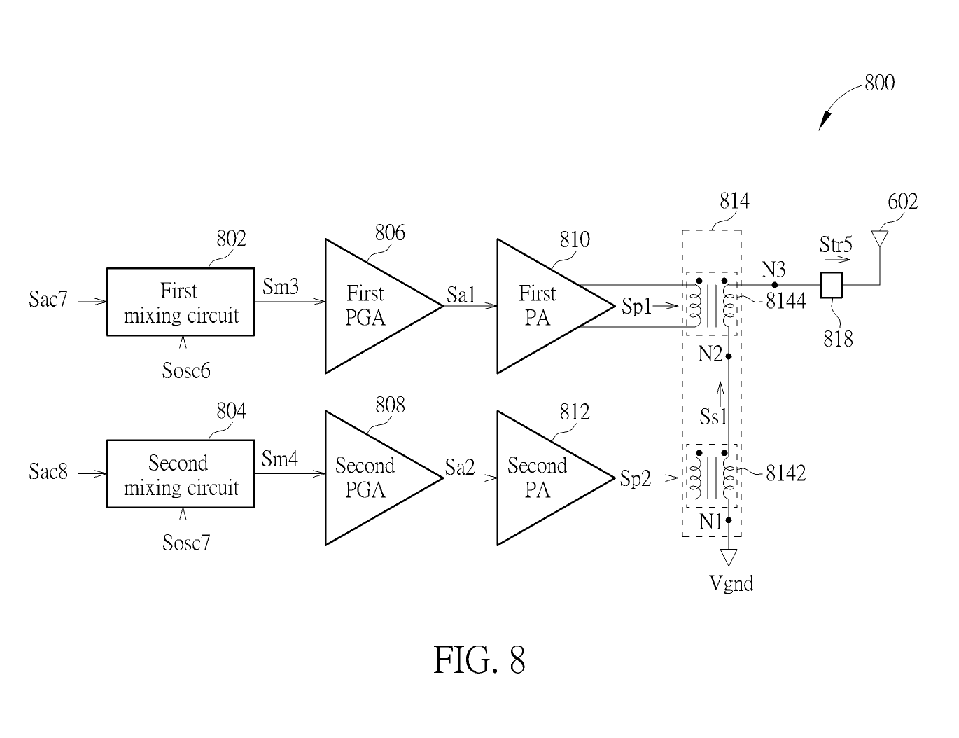

Please refer to FIG. 8, which is a diagram illustrating a transmitter 800 according to a second embodiment of the present invention. Similarly, the transmitter 800 can be the transmitter in the A-band transceivers 6102, 6122, and the G-band transceivers 6104, 6124. The transmitter 800 comprises a first mixing circuit 802, a second mixing circuit 804, a first programmable gain amplifier 806, a second programmable gain amplifier 808, a first power amplifier 810, a second power amplifier 812, a combiner 814, and the antenna 602. The combiner 814 comprises a first Balun (Balance-unbalance) circuit 8142 and a second Balun circuit 8144. The first mixing circuit 802 is arranged to modulate the seventh analog signal Sac7 to generate a third modulated signal Sm3 according to the sixth oscillating signal Sosc6. The second mixing circuit 804 is arranged to modulate the eighth analog signal Sac8 to generate a fourth modulated signal Sm4 according to the seventh oscillating signal Sosc7. The first programmable gain amplifier 806 is arranged to generate a first programmable signal Sa1 according to the third modulated signal Sm3. The second programmable gain amplifier 808 is arranged to generate a second programmable signal Sa2 according to the fourth modulated signal Sm4. The first power amplifier 810 is arranged to generate a first amplified signal Sp1 according to the first programmable signal Sa1. The second power amplifier 812 is arranged to generate a second amplified signal Sp2 according to the second programmable signal Sa2. The combiner 814 is arranged to generate the fifth transmitting signal Str5, i.e. the combined signal of the first amplified signal Sp1 and the second amplified signal Sp2.

In this embodiment, the first amplified signal Sp1 and the second amplified signal Sp2 are differential signals, so the first amplified signal Sp1 and the second amplified signal Sp2 should be converted into a single-ended signal before transmission by using the combiner 814. The first Balun circuit 8142 is coupled to the second power amplifier 812. The second Balun circuit 8144 is coupled to the first power amplifier 810 and the first Balun circuit 8142, wherein the first Balun circuit 8142 and the second Balun circuit 8144 are arranged to output the fifth transmitting signal Str5 according to the first amplified signal Sp1 and the second amplified signal Sp2. More specifically, a first output terminal N1 of the first Balun circuit 8142 is coupled to the ground voltage Vgnd, and a second output terminal N2 of the first Balun circuit 8142 is coupled to the second Balun circuit 8144, wherein a first single-ended signal Ss1 is generated at the second output terminal N2 of the first Balun circuit 8142. The second output terminal N3 of the second Balun circuit 8144 is coupled to the antenna 602 via an input/output (I/O) port 818, and a second single-ended signal (i.e. the fifth transmitting signal Str5) is generated at the second output terminal N3 of the second Balun circuit 8144. It should be noted that the first diplexer 606 as shown in FIG. 6 is omitted in FIG. 8 for the sake of brevity.

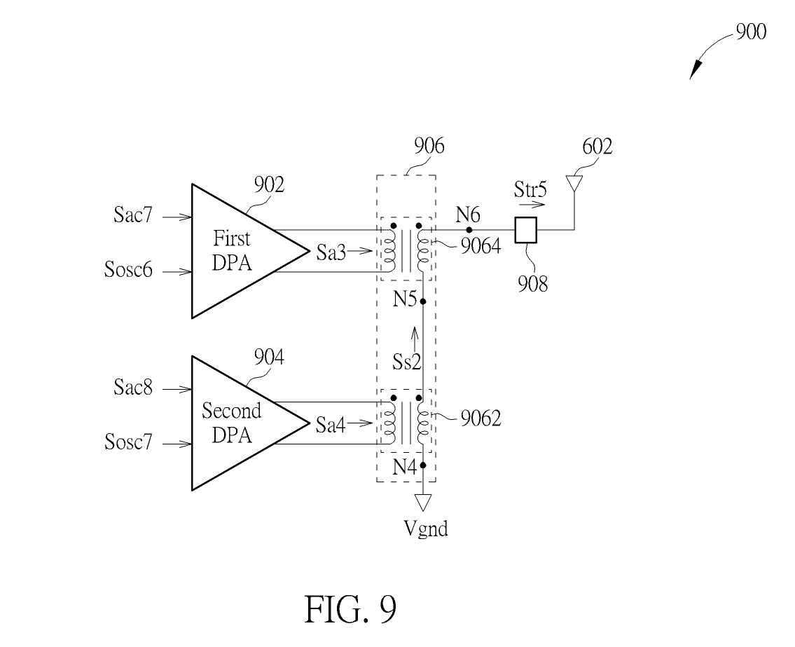

Please refer to FIG. 9, which is a diagram illustrating a transmitter 900 according to a third embodiment of the present invention. Similarly, the transmitter 900 can be the transmitter in the A-band transceivers 6102, 6122, and the G-band transceivers 6104, 6124. The transmitter 900 comprises a first DPA circuit 902, a second DPA circuit 904, a combiner 906, and the antenna 602. The first DPA circuit 902 is arranged to generate a third amplified signal Sa3 according to the seventh analog signal Sac7 and the sixth oscillating signal Sosc6. The second DPA circuit 904 is arranged to generate a fourth amplified signal Sa4 according to the eighth analog signal Sac8 and the seventh oscillating signal Sosc7. The combiner 906 is arranged to generate the fifth transmitting signal Str5 according to the third amplified signal Sa3 and the fourth amplified signal Sa4, i.e. a combined signal of the third amplified signal Sa3 and the fourth amplified signal Sa4. The combiner 906 comprises a first Balun circuit 9062 and a second Balun circuit 9064. The first Balun circuit 9062 is coupled to the second DPA circuit 904. The second Balun circuit 9064 is coupled to the first DPA circuit 902 and the first Balun circuit 9062, wherein the first Balun circuit 9062 and the second Balun circuit 9064 are arranged to output the fifth transmitting signal Str5 according to the third amplified signal Sa3 and the fourth amplified signal Sa4. More specifically, a first output terminal N4 of the first Balun circuit 9062 is coupled to the ground voltage Vgnd, and a second output terminal N5 of the first Balun circuit 9062 is coupled to the second Balun circuit 9064, wherein a first single-ended signal Ss2 is generated at the second output terminal N5 of the first Balun circuit 9062. The second output terminal N6 of the second Balun circuit 9064 is coupled to the antenna 602 via an input/output (I/O) port 908, and a second single-ended signal (i.e. the fifth transmitting signal Str5) is generated at the second output terminal N6 of the second Balun circuit 9064. It should be noted that the first diplexer 606 as shown in FIG. 6 is omitted in FIG. 9 for the sake of brevity.

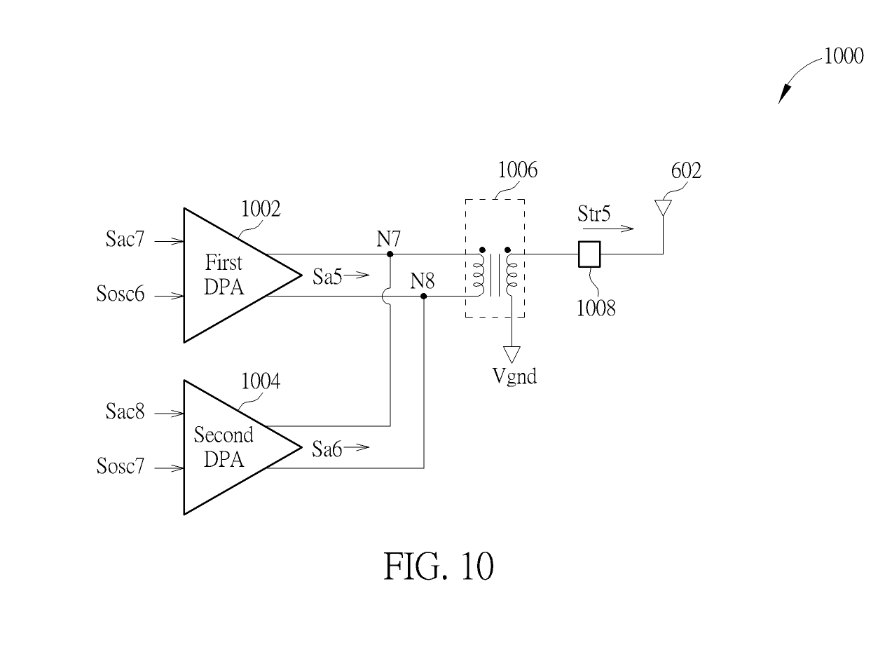

Please refer to FIG. 10, which is a diagram illustrating a transmitter 1000 according to a fourth embodiment of the present invention. Similarly, the transmitter 1000 can be the transmitter in the A-band transceivers 6102, 6122, and the G-band transceivers 6104, 6124. The transmitter 1000 comprises a first DPA circuit 1002, a second DPA circuit 1004, a combiner 1006, and the antenna 602. The first DPA circuit 1002 is arranged to generate a fifth amplified signal Sa5 according to the seventh analog signal Sac7 and the sixth oscillating signal Sosc6. The second DPA circuit 1004 is arranged to generate a sixth amplified signal Sa6 according to the eighth analog signal Sac8 and the seventh oscillating signal Sosc7. The combiner 1006 is arranged to generate the fifth transmitting signal Str5 according to the fifth amplified signal Sa5 and the sixth amplified signal Sa6, i.e. a combined signal of the fifth amplified signal Sa5 and the sixth amplified signal Sa6.

The combiner 1006 comprises a Balun circuit. The Balun circuit is coupled to first DPA circuit 1002 and the second DPA circuit 1004 for outputting the fifth transmitting signal Str5 according to the fifth amplified signal Sa5 and the sixth amplified signal Sa6. More specifically, the Balun circuit has two input terminals N7 and N8 for receiving the fifth amplified signal Sa5 and the sixth amplified signal Sa6 concurrently, in which the fifth amplified signal Sa5 and the sixth amplified signal Sa6 are differential signals. Then, the Balun circuit generates the single-ended output signal (i.e. the fifth transmitting signal Str5) to the antenna 602 via an input/output (I/O) port 1008 according to the fifth amplified signal Sa5 and the sixth amplified signal Sa6. It should be noted that the first diplexer 606 as shown in FIG. 6 is omitted in FIG. 10 for the sake of brevity.

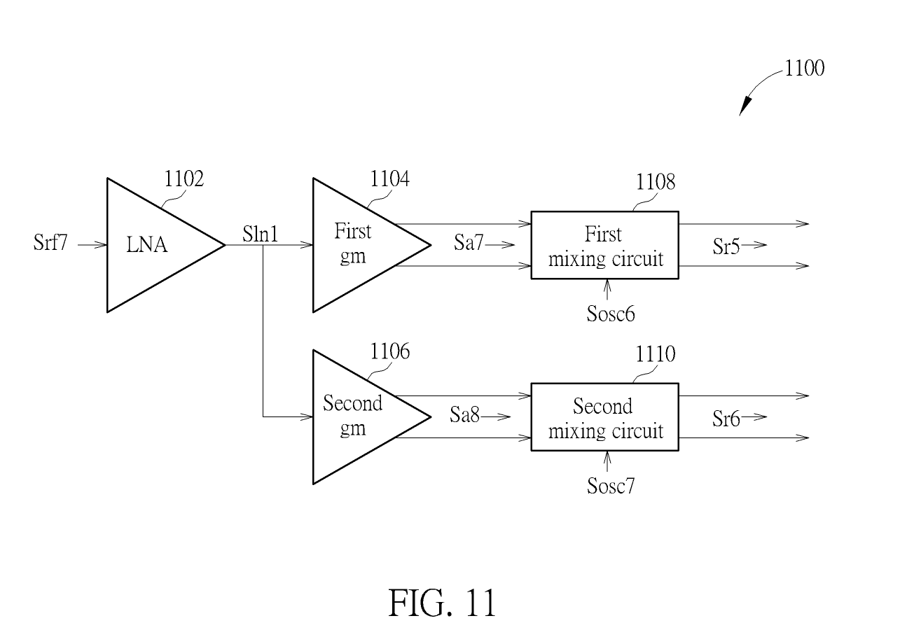

Please refer to FIG. 11, which is a diagram illustrating a receiver 1100 according to a first embodiment of the present invention. The receiver 1100 can be the receiver in the A-band transceivers 6102, 6122, and the G-band transceivers 6104, 6124. The receiver 1100 comprises a low-noise amplifier (LNA) 1102, a first transconducting circuit (gm) 1104, a second transconducting circuit 1106, a first mixing circuit 1108, and a second mixing circuit 1110. The low-noise amplifier 1102 is arranged to receive the seventh RF signal Srf7 to generate a first low-noise signal Sln1. The first transconducting circuit 1104 is arranged to generate a first differential analog signals Sa7 according to the first low-noise signal Sln1. The second transconducting circuit 1106 is arranged to generate a second differential analog signals Sa8 according to the first low-noise signal Sln1. The first mixing circuit 1108 is arranged to down-convert the first differential analog signals Sa7 to generate a first down-converted signal (i.e. the fifth receiving analog signal Sr5) according to the sixth oscillating signal Sosc6. The second mixing circuit 1110 is arranged to down-convert the second differential analog signals Sa8 to generate a second down-converted signal (i.e. the sixth receiving analog signal Sr6) according to the seventh oscillating signal Sosc7. It should be noted that the fifth receiving analog signal Sr5 and the sixth receiving analog signal Sr6 are differential signals.

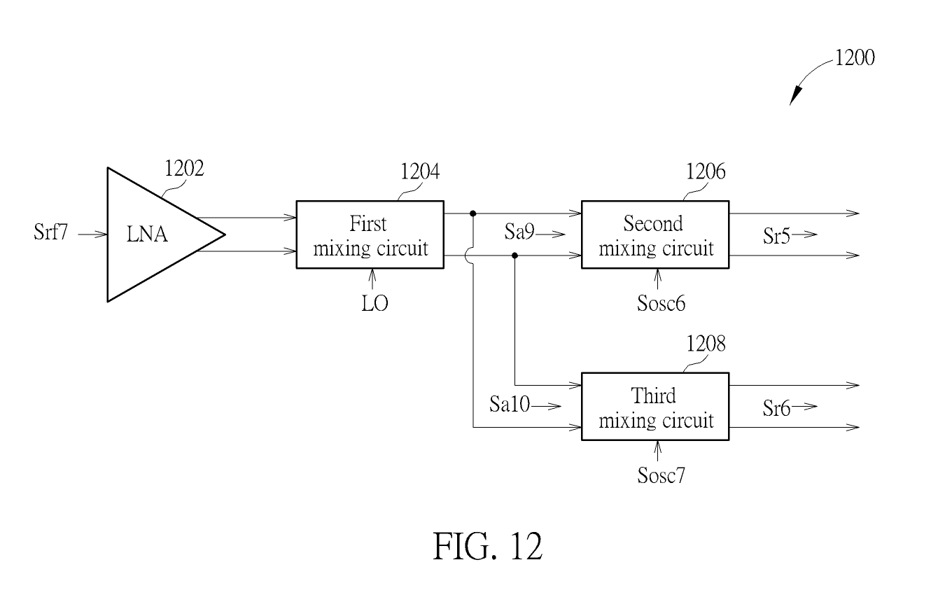

Please refer to FIG. 12, which is a diagram illustrating a receiver 1200 according to a second embodiment of the present invention. The receiver 1200 can be the receiver in the A-band transceivers 6102, 6122, and the G-band transceivers 6104, 6124. The receiver 1200 comprises a low-noise amplifier (LNA) 1202, a first mixing circuit 1204, a second mixing circuit 1206, and a third mixing circuit 1208. The low-noise amplifier 1202 is arranged to receive the seventh RF signal Srf7 to generate a second low-noise signal Sln2. The first mixing circuit 1204 is arranged to use an oscillating signal LO to down-convert the second low-noise signal Sln2 into the first differential analog signals Sa9 and the second differential analog signals Sa10. The second mixing circuit 1206 is arranged to down-convert the first differential analog signals Sa9 to generate a first down-converted signal (i.e. the fifth receiving analog signal Sr5) according to the sixth oscillating signal Sosc6. The third mixing circuit 1208 is arranged to down-convert the second differential analog signals Sa10 to generate a second down-converted signal (i.e. the sixth receiving analog signal Sr6) according to the seventh oscillating signal Sosc7. It should be noted that the first differential analog signals Sa9 is the same as the second differential analog signals Sa10. The low-noise amplifier 1202 is also arranged to convert the single-ended signal (i.e. the seventh RF signal Srf7) into a differential signals (i.e. the second low-noise signal Sln2). Moreover, the second mixing circuit 1206 and the third mixing circuit 1208 are digital mixers.

It should be noted that, other than the single antenna mode, the multi-standards transceiver 600 can also be arranged to operate under several double antennas modes, i.e. the first, second, and third frequency modes as described in the above multi-standards transceiver 100. When the multi-standards transceiver 600 operates under the first frequency mode, the multi-standards transceiver 600 is arranged to transmit/receive the RF signal on the frequency channels consists of two non-contiguous channels on a frequency band as shown in FIG. 2. Therefore, the first synthesizer 614 is arranged to generate a first oscillating signal to modulate (e.g. up-convert/down-convert) an analog signal corresponding to the first frequency channel 202, and the second synthesizer 616 is arranged to generate a second oscillating signal to modulate (e.g. up-convert/down-convert) an analog signal corresponding to the second frequency channel 204 during the first frequency mode of the multi-standards transceiver 600.

When the multi-standards transceiver 600 operates under the second frequency mode, the multi-standards transceiver 600 is arranged to transmit/receive the RF signal on one contiguous frequency channel on a frequency band as shown in FIG. 3. Therefore, the first synthesizer 614 is arranged to generate a third oscillating signal to the first transceiver 610 and the second transceiver 612 to modulate (e.g. up-convert/down-convert) an analog signal corresponding to the frequency channel 302 during the second frequency mode of the multi-standards transceiver 600.

When the multi-standards transceiver 600 operates under the third frequency mode, the multi-standards transceiver 600 is arranged to transmit/receive the RF signal on the frequency channels consists of two different frequency bands concurrently, the first frequency band corresponds to a first communications standard and the second frequency band corresponds to a second communications standard different from the first communications standard. Therefore, the first synthesizer 614 is arranged to generate a fourth oscillating signal to the receiver in the A-band transceiver 6102 (or the G-band transceiver 6104) to modulate (e.g. down-convert) an RF signal on the first frequency band for generating an analog signal to the ADC in the first signal converter 618. Meanwhile, the second synthesizer 616 is arranged to generate a fifth oscillating signal to the transmitter in the G-band transceiver 1124 (or the A-band transceiver 6124) to modulate (e.g. up-convert) another analog signal generated by the DAC in the second signal converter 620 into another RF signal for the second antenna 604.

One of ordinary skill in the art should understand the above-mentioned frequency modes of the multi-standards transceiver 600; the detailed description is therefore omitted for brevity.

Briefly, by installing two synthesizers into a single chip for generating two different oscillating signals concurrently, the above-mentioned multi-standards transceivers 100 and 600 are able to transmit/receive the RF signal on two non-contiguous channels on a first frequency band, to transmit/receive the RF signal on one contiguous channel on a second frequency band, and to transmit/receive the RF signal on the frequency channels consists of two different frequency bands concurrently. In comparison to the conventional methods, the present embodiment provides a one-chip solution for the multi-standards transceiver, thus the cost is lower than in a conventional transceiver.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A multi-standards transceiver, comprising:
a first synthesizer, arranged to generate a first oscillating signal;
a second synthesizer, arranged to generate a second oscillating signal;
a first transceiver;
a second transceiver; and
a multiplexer, coupled to the first synthesizer and the second synthesizer;
wherein when the multi-standards transceiver operates under a first frequency mode, the first transceiver is arranged to use the first oscillating signal to modulate a first analog signal and the multiplexer is arranged to output the second oscillating signal to the second transceiver so that the second transceiver uses the second oscillating signal to modulate a second analog signal.

2. The multi-standards transceiver of claim 1, wherein the first frequency mode is a mode where the first analog signal and the second analog signal belong to a first frequency channel and a second frequency channel respectively, and the first frequency channel and the second frequency channel are two non-contiguous channels in a frequency band of a communications standard.

3. The multi-standards transceiver of claim 1, wherein when the multi-standards transceiver is operated under a second frequency mode, the first transceiver is arranged to use the first oscillating signal to modulate a third analog signal, and the multiplexer is arranged to output the first oscillating signal to the second transceiver so that the second transceiver uses the first oscillating signal to modulate a fourth analog signal.

4. The multi-standards transceiver of claim 3, wherein the second frequency mode is a mode where the third analog signal and the fourth multi-standards analog signal belong to a single contiguous frequency channel in a frequency band of a communications standard.

5. The multi-standards transceiver of claim 1, wherein the first frequency mode is a mode where the first analog signal and the second analog signal belong to a first frequency band and a second frequency band respectively, and the first frequency band corresponds to a first communications standard and the second frequency band corresponds to a second communications standard different from the first communications standard.

6. The multi-standards transceiver of claim 1, wherein the first synthesizer, the second synthesizer, and the multiplexer are configured within a single chip.

7. The multi-standards transceiver of claim 1, further comprising:
a first signal converter, arranged to convert a first input digital signal into the first analog signal during a transmitting mode of the first transceiver, or convert the first analog signal into a first digital output signal during a receiving mode of the first transceiver; and
a second signal converter, arranged to convert a second input digital signal into the second analog signal during the transmitting mode of the second transceiver, or convert the second analog signal into a second digital output signal during the receiving mode of the second transceiver.

8. A multi-standards transceiver, comprising:
a first synthesizer, arranged to generate a first oscillating signal;
a second synthesizer, arranged to generate a second oscillating signal;
a first transceiver; and
a second transceiver;
wherein when the multi-standards transceiver operates under a first frequency mode, the first transceiver is arranged to use the first oscillating signal and the second oscillating signal to modulate a first analog signal and a second analog signal, respectively.

9. The multi-standards transceiver of claim 8, wherein the first frequency mode is a mode where the first analog signal and the second analog signal belong to a first frequency channel and a second frequency channel respectively, and the first frequency channel and the second frequency channel are two non-contiguous channels in a frequency band of a communications standard.

10. The multi-standards transceiver of claim 8, wherein when the multi-standards transceiver operates under the first frequency mode, the second transceiver is disabled.

11. The multi-standards transceiver of claim 8, wherein when the multi-standards transceiver is operated under a second frequency mode, the first transceiver is arranged to use the first oscillating signal to modulate a third analog signal, and the second transceiver is arranged to use the second oscillating signal to modulate a fourth analog signal.

12. The multi-standards transceiver of claim 11, wherein the second frequency mode is a mode where the third analog signal and the fourth analog signal belong to a first frequency band and a second frequency band respectively, and the first frequency band corresponds to a first communications standard and the second frequency band corresponds to a second communications standard different from the first communications standard.

13. The multi-standards transceiver of claim 8, wherein the first synthesizer and the second synthesizer are configured within a single chip.

14. The multi-standards transceiver of claim 8, further comprising:
a first signal converter, arranged to convert a first input digital signal into the first analog signal during a transmitting mode of the first transceiver, or convert the first analog signal into a first digital output signal during a receiving mode of the first transceiver; and
a second signal converter, arranged to convert a second input digital signal into the second analog signal during the transmitting mode of the first transceiver, or convert the second analog signal into a second digital output signal during the receiving mode of the first transceiver.

15. The multi-standards transceiver of claim 8, wherein the first transceiver comprises:
a first mixing circuit, arranged to modulate the first analog signal to generate a first modulated signal according to the first oscillating signal;
a second mixing circuit, arranged to modulate the second analog signal to generate a second modulated signal according to the second oscillating signal;
a programmable gain amplifier, arranged to combine the first modulated signal and the second modulated signal to generate a combined signal; and
a power amplifier, arranged to generate an amplified signal according to the combined signal.

16. The multi-standards transceiver of claim 8, wherein the first transceiver comprises:
a first mixing circuit, arranged to modulate the first analog signal to generate a first modulated signal according to the first oscillating signal;
a second mixing circuit, arranged to modulate the second analog signal to generate a second modulated signal according to the second oscillating signal;
a first programmable gain amplifier, arranged to generate a first programmable signal according to the first modulated signal;
a second programmable gain amplifier, arranged to generate a second programmable signal according to the second modulated signal;
a first power amplifier, arranged to generate a first amplified signal according to the first programmable signal;
a second power amplifier, arranged to generate a second amplified signal according to the second programmable signal; and
a combiner, arranged to generate a combined signal according to the first amplified signal and the second amplified signal.

17. The multi-standards transceiver of claim 16, wherein the combiner comprises:
a first Balun (Balance-unbalance) circuit, coupled to the second power amplifier; and
a second Balun circuit, coupled to the first power amplifier and the first Balun circuit;
wherein the first Balun circuit and the second Balun circuit are arranged to output the combined signal according to the first amplified signal and the second amplified signal.

18. The multi-standards transceiver of claim 8, wherein the first transceiver comprises:
a first DPA circuit, arranged to generate a first amplified signal according to the first analog signal and the first oscillating signal;
a second DPA circuit, arranged to generate a second amplified signal according to the second analog signal and the second oscillating signal; and
a combiner, arranged to generate a combined signal according to the first amplified signal and the second amplified signal.

19. The multi-standards transceiver of claim 18, wherein the combiner comprises:
a first Balun circuit, coupled to the second DPA circuit; and
a second Balun circuit, coupled to the first DPA circuit and the first Balun circuit;
wherein the first Balun circuit and the second Balun circuit are arranged to output the combined signal according to the first amplified signal and the second amplified signal.

20. The multi-standards transceiver of claim 18, wherein the combiner comprises:
a Balun circuit, coupled to the first DPA circuit and the second DPA circuit, for outputting the combined signal according to the first amplified signal and the second amplified signal.

21. The multi-standards transceiver of claim 8, wherein the first transceiver comprises:
a low-noise amplifier, arranged to receive an RF signal to generate a low-noise signal;
a first transconducting circuit, arranged to generate the first analog signal according to the low-noise signal;
a second transconducting circuit, arranged to generate the second analog signal according to the low-noise signal;
a first mixing circuit, arranged to down-convert the first analog signal to generate a first down-converted signal according to the first oscillating signal; and
a second mixing circuit, arranged to down-convert the second analog signal to generate a second down-converted signal according to the second oscillating signal.

22. The multi-standards transceiver of claim 8, wherein the first transceiver comprises:
a low-noise amplifier, arranged to receive an RF signal to generate a low-noise signal;
a first mixing circuit, arranged to down-convert the low-noise signal into the first analog signal and the second analog signal;
a second mixing circuit, arranged to down-convert the first analog signal to generate a first down-converted signal according to the first oscillating signal; and
a third mixing circuit, arranged to down-convert the second analog signal to generate a second down-converted signal according to the second oscillating signal.
